(19) United States
(12) Patent Application Publication
(10) Pub. No.: US 2026/0162531 A1
(43) Pub. Date: Jun. 11, 2026

(54) METHOD AND SYSTEM FOR DETERMINING TRAFFIC CONGESTION

(71) Applicant: HL Klemove Corp., Incheon (KR)

(72) Inventor: Jaeik JANG, Incheon (KR)

(73) Assignee: HL Klemove Corp., Incheon (KR)

(21) Appl. No.: 19/091,943

(22) Filed: Mar. 27, 2025

(30) Foreign Application Priority Data
Dec. 11, 2024 (KR) 10-2024-0183562

(51) Int. Cl. G08G 1/0967; B60W 10/18; B60W 10/20; B60W 30/14; G08G 1/01; G08G 1/052

(52) U.S. Cl. CPC G08G 1/096725; B60W 10/18; B60W 10/20; B60W 30/146; G08G 1/0112; G08G 1/0133; G08G 1/052; B60W 2420/403; B60W 2420/408; B60W 2554/4042; B60W 2554/406; B60W 2556/40; B60W 2556/50

(57) ABSTRACT

A method for determining traffic congestion according to an embodiment of the present disclosure comprises: collecting road information on which the vehicle is driving and information on at least one surrounding vehicle driving in an adjacent lane using at least one sensor; aligning the at least one surrounding vehicle based on a longitudinal distance from an ego vehicle and allocating at least one slot to the at least one surrounding vehicle, and determining retention or transition of the slot; determining vehicle driving speed of the adjacent lane by using vehicle speed of the at least one surrounding vehicle; calculating congestion degree of the adjacent lane in a congestion section based on a one-dimensional traffic flow model; determining whether there is traffic congestion in the adjacent lane by using the congestion degree of the adjacent lane; and controlling the ego vehicle according to whether there is the traffic congestion.

### CROSS-REFERENCE TO RELATED APPLICATION

This application claims the benefit of and priority to Korean Patent Application No. 2024-0183562 filed on Dec. 11, 2024, the entire disclosures of which are incorporated herein by reference.

### TECHNICAL FIELD

The present disclosure relates to a method and system for determining traffic congestion. More specifically, the present disclosure relates to a method and system for determining traffic congestion by using a one-dimensional traffic flow model.

### BACKGROUND

In vehicles, the Autonomous Driving System provides the function of recognizing the surrounding environment, determining the driving situation, and controlling the vehicle to drive to a given destination without an operation of the driver.

Meanwhile, traffic congestion may occur on the road depending on the number of vehicles passing through the road. In order to drive efficiently, it is necessary to determine whether there is traffic congestion in the adjacent lane and control the vehicle accordingly.

Previously, there was a technology to determine congested areas based on grid maps using fixed cameras based on V2X (Vehicle to Everything), but since the infrastructure is not built on every road, there are physical limitations to its widespread application.

Therefore, there is a need for a method and system for determining traffic congestion that can determine whether there is congestion in an adjacent lane using sensors mounted at vehicles regardless of the road infrastructure.

### SUMMARY

The present disclosure is to solve the above-mentioned problems of the prior art, and the object of the present disclosure is to provide a method and system for determining traffic congestion, which can determine whether there is traffic congestion in an adjacent lane by using only the sensors mounted at the vehicle, regardless of the road infrastructure.

In addition, the object of the present disclosure is to provide a method and system for determining traffic congestion by using road information and information on surrounding vehicles to determine whether there is traffic congestion in the adjacent lane, thereby enabling a quick response when entering the traffic congestion section, and promoting efficient driving of the ego vehicle by avoiding the traffic congested lane.

However, the technical problem to be achieved by the embodiments of the present disclosure is not limited to the technical problems described above, and other technical problems may exist.

As a technical means for achieving the above technical problem, a method for determining traffic congestion according to an embodiment of the present disclosure comprises: collecting road information on which the vehicle is driving and information on at least one surrounding vehicle driving in an adjacent lane using at least one sensor; aligning the at least one surrounding vehicle based on a longitudinal distance from an ego vehicle and allocating at least one slot to the at least one surrounding vehicle, and determining retention or transition of the slot; determining vehicle driving speed of the adjacent lane by using vehicle speed of the at least one surrounding vehicle; calculating congestion degree of the adjacent lane in a congestion section based on a one-dimensional traffic flow model; determining whether there is traffic congestion in the adjacent lane by using the congestion degree of the adjacent lane; and controlling the ego vehicle according to whether there is the traffic congestion.

Further, in determining retention or transition of the slot, it may be determined that the slot is retained if the number of at least one surrounding vehicle satisfying the retention time set for each slot is greater than a predetermined threshold value.

Further, the set retention time may become longer as a distance of the slot from the ego vehicle increases.

Further, in determining retention or transition of the slot, it may be determined that the slot is transitioned if the number of at least one surrounding vehicle satisfying the number of transitions set for each slot is greater than a predetermined threshold value.

Further, the number of transitions set for each slot may increase as a distance of the slot from the ego vehicle increases.

Further, the method for determining traffic congestion may comprise setting s destination of the ego vehicle; and generating a route to reach the destination of the ego vehicle.

Further, the controlling of the ego vehicle may comprise controlling the ego vehicle according to the route and whether there is the traffic congestion.

Further, the determining of the vehicle driving speed of the adjacent lane may be performed by using an average driving speed of vehicles driving in the adjacent lane.

Further, the controlling of the ego vehicle may comprise performing deceleration control of the ego vehicle to reduce a speed of the ego vehicle to be the same as the vehicle driving speed of the adjacent lane if the adjacent lane is determined to be congested when the ego vehicle enters the adjacent lane.

Further, the calculating of the congestion degree may comprise determining the congestion section variably depending on a type and a maximum detection distance of the at least one sensor of the ego vehicle.

A system for determining traffic congestion according to the embodiments of the present disclosure comprises: a first sensor configured to detect information of at least one surrounding vehicle driving in an adjacent lane; a second sensor configured to detect road information on which an ego vehicle is driving; and a controller comprising at least one processor configured to determine whether there is traffic congestion in the adjacent lane, wherein the controller is configured to allocate at least one slot by aligning the at least one surrounding vehicle based on a longitudinal distance from the ego vehicle, determine retention or transition of the slot, determine vehicle driving speed of the adjacent lane using vehicle speed of the at least one surrounding vehicle, calculate congestion degree of the adjacent lane in a congestion section based on a one-dimensional traffic flow model, determine whether there is traffic congestion in the adjacent lane by using the congestion degree of the adjacent lane, and control the ego vehicle based on the result of determining whether there is traffic congestion.

Further, the system for determining traffic congestion may comprise: a braking apparatus configured to control a longitudinal driving of the ego vehicle; and a steering apparatus configured to control a lateral driving of the ego vehicle, wherein the controller may be configured to control at least one of the braking apparatus and the steering apparatus based on the result of determining whether there is traffic congestion.

Further, the first sensor may comprise at least one of a front camera, a front radar, and a corner radar, and the second sensor may comprise at least one of a GNSS (Global Navigation Satellite System), an IMU (Inertial Measurement Unit), and a navigation map.

Further, the controller may be configured to determine that the slot is retained if the number of at least one surrounding vehicle satisfying the retention time set for each slot is greater than a predetermined threshold value, and the set retention time may become longer as a distance of the slot from the ego vehicle increases.

Further, the controller may be configured to determine that the slot is transitioned if the number of at least one surrounding vehicle satisfying the number of transitions set for each slot is greater than a predetermined threshold value, and the set number of transitions may increase as a distance of the slot from the ego vehicle increases.

Further, the controller may be configured to generate a route to reach a destination set for the ego vehicle, and control the ego vehicle based on the route and whether there is traffic congestion.

Further, the controller may be configured to determine the vehicle driving speed of the adjacent lane by using an average driving speed of vehicles driving in the adjacent lane.

Further, the controller may be configured to perform deceleration control of the ego vehicle to reduce a speed of the ego vehicle to be the same as the vehicle driving speed of the adjacent lane if the adjacent lane is determined to be congested when the ego vehicle enters the adjacent lane.

Further, the controller may be configured to variably determine the congestion section depending on a type and a maximum detection distance of at least one sensor included in the first sensor.

In a non-transitory computer-readable recording medium that records a program for executing a method for determining traffic congestion according to an embodiment of the present disclosure, the method comprises: collecting road information on which the vehicle is driving and information on at least one surrounding vehicle driving in an adjacent lane using at least one sensor; aligning the at least one surrounding vehicle based on a longitudinal distance from an ego vehicle and allocating at least one slot to the at least one surrounding vehicle, and determining retention or transition of the slot; determining vehicle driving speed of the adjacent lane by using vehicle speed of the at least one surrounding vehicle; calculating congestion degree of the adjacent lane in a congestion section based on a one-dimensional traffic flow model; determining whether there is traffic congestion in the adjacent lane by using the congestion degree of the adjacent lane; and controlling the ego vehicle according to whether there is the traffic congestion.

The above-described means for solving the problem is only exemplary and should not be construed as limiting the present disclosure. In addition to the exemplary embodiments described above, additional embodiments may exist in the drawings and the following detailed description.

According to the above-described problem-solving means of the present disclosure, it is possible to provide a method and system for determining traffic congestion that can determine traffic congestion in the adjacent lane regardless of the road infrastructure, by utilizing information collected through at least one sensor mounted at the vehicle to determine traffic congestion in the adjacent lane.

In addition, according to the present disclosure, it is possible to provide a method and system for determining traffic congestion that can promptly respond to traffic congestion in the adjacent lane and promote efficient driving of the vehicle by determining whether there is traffic congestion in the adjacent lane using road information and information on at least one surrounding vehicle.

However, the effects obtainable from the present disclosure are not limited to the effects described above, and other effects may exist.

### BRIEF DESCRIPTION OF THE DRAWINGS

FIG. 1 is a control flowchart showing a method for determining traffic congestion according to an embodiment of the present disclosure.

FIG. 2 is a drawing showing a method of allocating slots by arranging at least one surrounding vehicle based on the longitudinal distance from the ego vehicle in the method for determining traffic congestion according to the embodiment of the present disclosure.

FIG. 3 is a drawing exemplarily showing retention time set for each slot in the method for determining traffic congestion according to the embodiment of the present disclosure.

FIG. 4 is a diagram exemplarily showing the number of transitions set for each slot in the method for determining traffic congestion according to the embodiment of the present disclosure.

FIG. 5 is a drawing for explaining a one-dimensional traffic flow model in the method for determining traffic congestion according to the embodiment of the present disclosure.

FIG. 6 is a drawing for explaining a method of determining congestion degree in the adjacent lane using a one-dimensional traffic flow model in the method for determining traffic congestion according to the embodiment of the present disclosure.

FIG. 7 is a control configuration diagram schematically showing configuration of a traffic congestion determination system according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and system for determining traffic congestion, which determines whether there is traffic congestion in an adjacent lane based on a one-dimensional traffic flow model, and uses the determination result to promote efficient driving of the vehicle.

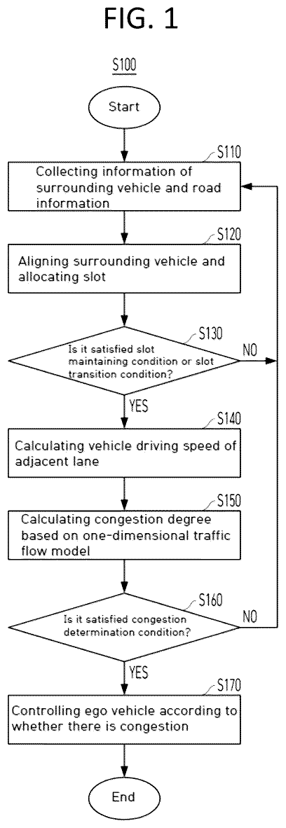

FIG. 1 is a control flowchart showing a method for determining traffic congestion according to an embodiment of the present disclosure.

Referring to FIG. 1, a method for determining traffic congestion S100 according to one embodiment of the present disclosure may comprises a step of collecting road information on which the ego vehicle is driving and information on at least one surrounding vehicle driving in an adjacent lane using at least one sensor S110.

In the information collection step S110, information on at least one surrounding vehicle may be collected through the front camera, front radar, and/or corner radar installed at the ego vehicle. Here, information on at least one surrounding vehicle may include, but is not limited to, the location, speed, and/or acceleration of the at least one surrounding vehicle, and may include all information on surrounding vehicles.

In addition, in the information collection step S110, the road information on which the ego vehicle is driving may be collected by at least one of GNSS (Global Navigation Satellite System), IMU (Inertial Measurement Unit), and navigation map information. Alternatively, the road information may be collected through a camera sensor.

Here, the road information may include lane shape information including the type and the color of the lane, and road shape information including the number of lanes, whether there is a merging section, etc.

Next, a step of aligning at least one surrounding vehicle based on the longitudinal distance from the ego vehicle and allocating at least one slot to the at least one surrounding vehicle S120 may be performed. Here, the at least one surrounding vehicle may be aligned for each lane based on the longitudinal distance from the ego vehicle, and the slot may be allocated to the at least one surrounding vehicle in the aligned state.

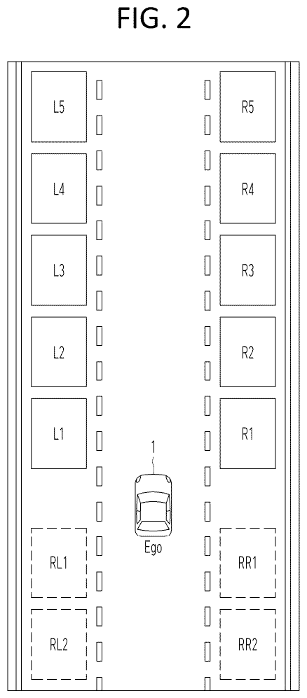

The method of aligning at least one surrounding vehicle and allocating the slot according to the embodiment of the present disclosure will be examined in more detail in the description of FIG. 2.

Next, determining whether a slot retention condition or a slot transition condition is satisfied S130 may be performed.

Here, the determination of the slot retention condition may determine whether the number of surrounding vehicles satisfying the retention time set for each slot is greater than a predetermined threshold value (a predetermined threshold number).

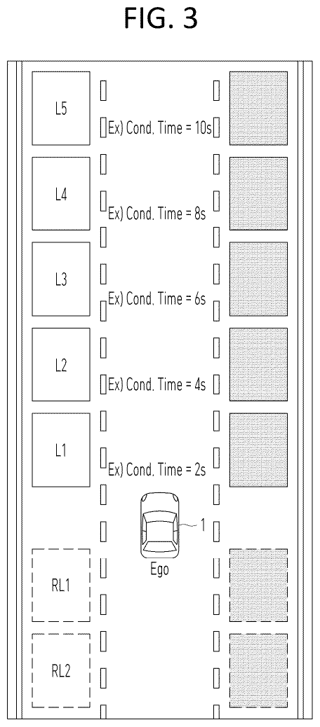

The retention time may be set differently for each slot, and for example, the longer the longitudinal distance between the vehicle and the slot, the longer the retention time may be set. The setting of the retention time and the determination of the slot retention conditions will be explained in more detail in the explanation of FIG. 3 below.

In addition, the determination of the slot transition condition may be to determine whether the number of surrounding vehicles satisfying the number of transitions set for each slot is greater than a predetermined threshold value (a predetermined threshold number).

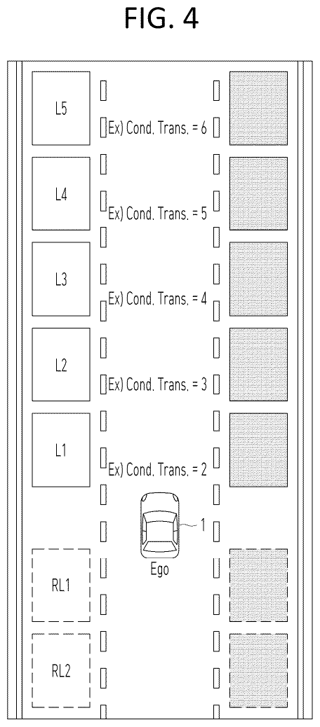

The number of transitions may be set differently for each slot, and for example, the longer the longitudinal distance between the vehicle and the slot, the greater the number of slot transitions may be set. The setting of the number of transitions and the determination of the slot transition condition will be specifically discussed in the description of FIG. 4 below.

Here, the step S130 may be performed to check the trend of driving speeds of surrounding vehicles driving in adjacent lanes.

For example, it is possible to determine whether the driving speeds of both the driving lane of the ego vehicle and the adjacent lane are low by determining whether the slot retention condition is satisfied. Here, the low speed may be a speed below a predetermined threshold value (a predetermined threshold speed).

In addition, it is possible to determine whether the driving speed of the ego vehicle is high and the driving speed of the adjacent lane is low by determining whether the slot transition condition is satisfied. Here, the high speed may be a speed higher than a predetermined threshold value, and the low speed may be a speed lower than a predetermined threshold value.

According to the method for determining traffic congestion according to the embodiment of the present disclosure, it is possible to supplement the reliability of the congestion degree calculated using information collected through limited sensors by checking the trend of the driving speed of the adjacent lane through the step S130.

Next, if the slot retention condition or the slot transition condition is satisfied (‘YES’ in S130), a step of calculating the vehicle driving speed of the adjacent lane S140 may be performed.

The vehicle driving speed of the adjacent lane may be calculated by averaging the speed values of surrounding vehicles driving in the adjacent lane. In addition, only reliable speed values among the speed values of surrounding vehicles may be selected and used to calculate the vehicle driving speed of the adjacent lane.

For example, the speed values of surrounding vehicles driving in the adjacent lane may be detected, the reliability of the detected speed values may be calculated, and then the speed values with reliability higher than a predetermined threshold value may be selected and averaged to calculate the vehicle driving speed in the adjacent lane.

For example, the reliability of the speed value may be calculated based on the number of sensors used to detect the speed value or the distances between the surrounding vehicles and the ego vehicle.

Next, a step of calculating congestion degree based on a one-dimensional traffic flow model S150 may be performed. Here, the congestion degree based on the one-dimensional traffic flow model may be calculated using road information collected through sensors mounted at the ego vehicle and information on surrounding vehicles.

In addition, the traffic congestion section where it is determined there is traffic congestion may be variably determined depending on the type of the at least one sensor installed at the ego vehicle and the maximum detection distance by the at least one sensor.

Therefore, according to the method for determining traffic congestion according to the embodiment of the present disclosure, unlike the conventional technology that could calculate the congestion degree only for a specific road section through a fixed camera installed on the road, it is possible to determine whether there is traffic congestion even for a road section where infrastructure has not been built and to efficiently control the ego vehicle in response to the traffic congestion.

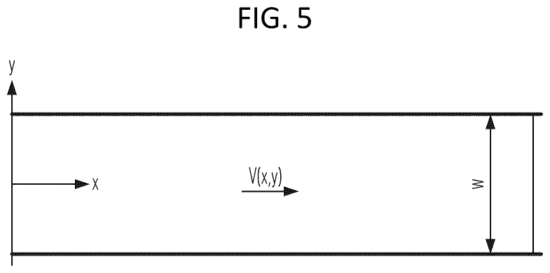

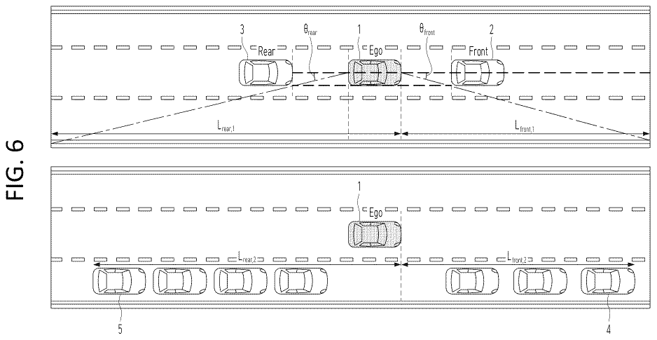

The method of calculating traffic congestion degree using the one-dimensional traffic flow model will be described in detail in the descriptions of FIGS. 5 and 6 below.

Next, a step of determining whether the adjacent lane is congested using the congestion degree S160 may be performed. For example, if the congestion degree is greater than a predetermined threshold value, it may be determined that the adjacent lane is congested (there is traffic congestion), and if the congestion degree is less than the predetermined threshold value, it may be determined that the adjacent lane is not congested (there is no traffic congestion).

Next, if the traffic congestion determination condition is satisfied (‘YES’ of S160), a step of controlling the ego vehicle depending on the traffic congestion S170 may be performed.

For example, when the vehicle is about to enter the adjacent lane and the adjacent lane is determined to be congested, a control may be performed to reduce the speed of the ego vehicle to be the same as the vehicle driving speed of the adjacent lane. Through this, when the ego vehicle needs to enter a congested adjacent lane according to the driving route of the ego vehicle, the timing of the lane change can be advanced.

In addition, for example, by determining whether the adjacent lane is congested, it is possible to promote efficient driving of the ego vehicle by allowing the ego vehicle to avoid the congested lane.

Meanwhile, in addition to the above, a step of setting a destination of the ego vehicle and a step of generating a route to reach the destination of the ego vehicle may be additionally performed. Here, the destination of the ego vehicle may be set through input to the navigation system, or the destination of the ego vehicle may be a preset destination for an autonomous vehicle.

If the destination is set in this way and the driving route is generated accordingly, the step of controlling the ego vehicle may be performed to control the ego vehicle according to the generated route and whether there is traffic congestion.

According to the method for determining traffic congestion according to the embodiment of the present disclosure as described above, it is possible to determine whether there is congestion even in an intermittently occurring congestion section and to respond quickly to the traffic congestion by constantly determining whether there is congestion in the adjacent lane using the traffic flow model.

In addition, according to the method for determining traffic congestion according to the embodiment of the present disclosure, a remarkable effect can be achieved in that the presence of traffic congestion can be determined regardless of the road infrastructure by only using the sensors mounted at the ego vehicle to determine whether there is traffic congestion in the adjacent lane.

FIG. 2 is a drawing showing a method of allocating slots by arranging at least one surrounding vehicle based on the longitudinal distance from the ego vehicle in the method for determining traffic congestion according to the embodiment of the present disclosure.

Referring to FIG. 2, after aligning at least one surrounding vehicle in the adjacent lane based on the longitudinal distance from the ego vehicle 1, a slot may be assigned to each surrounding vehicle. For example, after aligning surrounding vehicles in the left adjacent lane based on the longitudinal distance from the ego vehicle 1, slots L1, L2, L3, L4, and L5 may be assigned to the surrounding vehicles located in front side of the ego vehicle 1, and slots RL1 and RL2 may be assigned to surrounding vehicles located in rear side, respectively.

Similarly, after aligning the surrounding vehicles in the right adjacent lane based on the longitudinal distance from the ego vehicle 1, slots R1, R2, R3, R4, and R5 may be assigned to the surrounding vehicles located in front side of the ego vehicle 1, and slots RR1 and RR2 may be assigned to the surrounding vehicles located in rear side, respectively.

FIG. 3 is a drawing exemplarily showing retention time set for each slot in the method for determining traffic congestion according to the embodiment of the present disclosure.

Referring to FIG. 3, the retention time may be set differently for each slot, and the retention time may be set longer as the distance of the slot from the ego vehicle 1 increases.

For example, as shown in FIG. 3, the retention time for slots L1, L2, L3, L4, and L5 may be set to 2 seconds, 4 seconds, 6 seconds, 8 seconds, and 10 seconds, respectively. The set retention time is not limited thereto and may be set differently as needed.

Next, a method for determining whether the slot is retained (maintained) is described with reference to FIG. 3. First, it is determined whether each surrounding vehicle satisfies the retention time set for the corresponding slot. For example, if a surrounding vehicle located in slot L1 remains in slot L1 for more than 2 seconds, that is, if the position of the surrounding vehicle when aligned based on the longitudinal distance from the ego vehicle 1 remains without change for more than 2 seconds, it may be determined that the surrounding vehicle satisfies the retention time. Similarly, if a surrounding vehicle located in slot L2 remains in slot L2 for more than 4 seconds, it may be determined that the surrounding vehicle satisfies the retention time of the slot. Next, if the number of surrounding vehicles satisfying the retention time set for each slot is greater than or equal to a predetermined threshold value (a predetermined threshold number), it may be determined that the slot is retained.

FIG. 4 is a diagram exemplarily showing the number of transitions set for each slot in the method for determining traffic congestion according to the embodiment of the present disclosure.

Referring to FIG. 4, the number of transitions may be set differently for each slot, and the number of transitions may be set to be larger as the distance of the slot from the ego vehicle 1 increases.

For example, as shown in FIG. 4, the number of transitions may be set to 2, 3, 4, 5, and 6 for slots L1, L2, L3, L4, and L5, respectively. The number of transitions set is not limited thereto and may be set differently as needed.

Next, a method for determining the transition of a slot is described with reference to FIG. 4. First, it is determined whether each surrounding vehicle satisfies the number of transitions set for the corresponding slot. For example, if a surrounding vehicle located in slot L1 has transitioned more than twice, that is, if the position of the surrounding vehicle when aligned based on the longitudinal distance from the ego vehicle 1 has transitioned from L1 to L2 to L3, it may be determined that the surrounding vehicle satisfies the number of transitions of the corresponding slot. Similarly, if a surrounding vehicle located in slot L2 moves to slot L5 via slots L3 and L4, for example, it may be determined that the surrounding vehicle satisfies the transition number of the slot. Next, if the number of surrounding vehicles satisfying the number of transitions set for each slot is greater than a predetermined threshold value (a predetermined threshold number), it may be determined that the slot has been transitioned.

FIG. 5 is a drawing for explaining a one-dimensional traffic flow model in the method for determining traffic congestion according to the embodiment of the present disclosure.

The traffic flow model is a fluid equation-based measurement method mainly used in traffic engineering, and may calculate the congestion degree (Density) ρ by using the number of vehicles passing through the measurement section per hour (Total traffic volume; Flow) Q as the numerator and the average speed of the measurement section (Velocity) V as the denominator.

That is, the density (congestion degree) may be calculated as follows.

$$Density ( ρ , \text{?} ) = \frac{Flow ( \text{?} )}{Velocity ( \text{?} )} \qquad [ Equation 1 ]$$

$$\text{?} \text{indicates text missing or illegible when filed}$$

Referring to FIG. 5, the one-dimensional traffic flow model may assume that the density is uniform because only one vehicle can pass through each lane. Therefore, when the number of vehicles passing through the measurement section (detection section) N, the width of the lane W, the length of the measurement section L, and the maximum speed that can be driven V₀ are given, the congestion degree (Density) of the lane, the total traffic volume (Flow), and the vehicle speed of the congestion section (Velocity) may be expressed as follows.

$$Density ( {ρ}^{1 d} ) = {\int }_{- W / 2}^{W / 2} ρ ( x , y , t ) dy \approx W \cdot ρ ( x , t ) = W \cdot \frac{N}{L \cdot W} = \frac{N}{L} \qquad [ Equation 2 ]$$

$$Flow ( Q ) = {\int }_{- W / 2}^{W / 2} J ( x , y , t ) dy \approx W \cdot J ( x , t ) = W \cdot J ( {ρ}^{1 d} / W ) = W \cdot {V}_{0} \cdot \frac{{ρ}^{1 d}}{W} \cdot ( 1 - \frac{\text{?}}{\text{?}} ) = {V}_{0} \cdot {ρ}^{1 d} \cdot ( 1 - \frac{\text{?}}{{ρ}_{max}^{1 d}} ) \qquad [ Equation 3 ]$$

$$Velocity ( V ) = \frac{Q}{{ρ}^{1 d}} \qquad [ Equation 4 ]$$

$$\text{?} \text{indicates text missing or illegible when filed}$$

Next, FIG. 6 is a drawing for explaining a method of determining congestion degree in the adjacent lane using a one-dimensional traffic flow model in the method for determining traffic congestion according to the embodiment of the present disclosure.

For example, referring to FIG. 6, through a sensor mounted at an ego vehicle 1, the sum of the lengths of passing vehicles sum(ObjLen), a front measurement section L_{front,1} in consideration of the degree of obscuration by a front vehicle 2, a rear measurement section L_{rear,1} in consideration of the degree of obscuration by a rear vehicle 3, a distance L_{front,2} from the ego vehicle 1 to the front bumper of the frontmost surrounding vehicle 4 in the adjacent lane that can be detected by the sensor, and a distance L_{rear,2} from the ego vehicle 1 to the rear bumper of the rearmost surrounding vehicle 5 in the adjacent lane that can be detected by the sensor may be measured.

Then, from the above measurement values, the length of the congestion section (measurement section) L, which is the criterion for determining traffic congestion, can be expressed as follows.

$$L = max ( {L}_{front , 1} , {L}_{front , 2} ) + max ( {L}_{rear , 1} , {L}_{rear , 2} ) \qquad [ Equation 5 ]$$

That is, referring to FIG. 6, in the method for determining traffic congestion according to the embodiment of the present disclosure, the length of the congestion section L can be variably determined based on the type and maximum detection distance of at least one sensor installed at the ego vehicle 1, taking into consideration the front vehicle 2 and the rear vehicle 3.

Next, the traffic volume Q of the lane may be expressed as follows.

$$Q = {V}_{0} \cdot {ρ}_{raw}^{1 d} \cdot ( 1 - {ρ}_{raw}^{1 d} ) , where {ρ}_{raw}^{1 d} = \frac{sum ( ObjLen )}{L} \qquad [ Equation 6 ]$$

Compared to [Equation 2], in [Equation 6], it can be seen that the sum of the lengths of passing vehicles sum(ObjLen) is used instead of the number of vehicles N.

In addition, the congestion degree ρ^{1d} based on the one-dimensional traffic flow model according to the embodiment of the present disclosure may be expressed as follows.

$${ρ}^{1 d} = \frac{Q}{V} \qquad [ Equation 7 ]$$

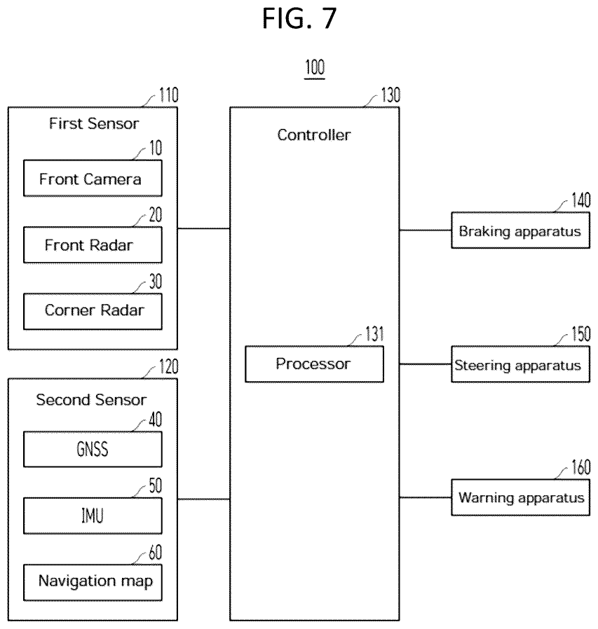

FIG. 7 is a control configuration diagram schematically showing configuration of a traffic congestion determination system according to embodiments of the present disclosure.

Referring to FIG. 7, the system for determining traffic congestion 100 according to embodiments of the present disclosure may comprise a first sensor 110 configured to detect information of at least one surrounding vehicle driving in an adjacent lane, a second sensor 120 configured to detect road information on which an ego vehicle is driving, and a controller 130 comprising at least one processor 131 configured to determine whether there is traffic congestion in the adjacent lane.

The controller 130 may allocate at least one slot by aligning at least one surrounding vehicle based on a longitudinal distance from the ego vehicle, determine retention or transition of the slots, determine the vehicle driving speed of the adjacent lane using vehicle speed of the at least one surrounding vehicle, calculate congestion degree of the adjacent lane in a congestion section based on a one-dimensional traffic flow model, determine whether there is traffic congestion in the adjacent lane by using the congestion degree of the adjacent lane, and control the ego vehicle based on the result of determining whether there is the traffic congestion.

The first sensor 110 may comprise at least one of a front camera 10, a front radar 20, and a corner radar 30. However, it is not limited thereto, and the first sensor 110 may include other types of sensors for detecting the surroundings of the ego vehicle, such as a rear camera, a rear radar, an ultrasonic sensor, or a lidar.

Information on at least one surrounding vehicle driving in an adjacent lane may be collected by at least one sensor included in the first sensor 110, and the congestion section may be variably determined depending on the type and the maximum detection distance of the at least one sensor.

The second sensor 120 may comprise at least one of a GNSS (Global Navigation Satellite System) 40, an IMU (Inertial Measurement Unit) 50, and a navigation map 60. However, it is not limited thereto, and the second sensor 120 may include other types of sensors or maps (e.g., a high-definition map, etc.) that can collect road information on which the ego vehicle is driving.

In addition, the controller 130 may determine that the slot is retained if the number of at least one surrounding vehicle satisfying the retention time set for each slot is greater than or equal to a predetermined threshold value, and may determine that the slot is transitioned if the number of at least one surrounding vehicle satisfying the number of transitions set for each slot is greater than or equal to a predetermined threshold value.

In addition, the controller 130 may generate a route to reach a destination set for the ego vehicle, and control the ego vehicle based on the generated route and based on whether there is traffic congestion.

Further, the controller 130 may be connected with a braking apparatus 140 configured to control a longitudinal driving of the ego vehicle and a steering apparatus 150 configured to control a lateral driving of the ego vehicle.

Accordingly, the controller 130 may control the ego vehicle by controlling at least one of the braking apparatus 140 and the steering apparatus 150 based on the result of determining whether there is traffic congestion. For example, in a case where the ego vehicle needs to enter the adjacent lane, if it is determined that the adjacent lane is congested, the braking apparatus 140 may be controlled to reduce the speed of the ego vehicle to the vehicle driving speed of the adjacent lane, and the steering apparatus 150 may be controlled to change lanes to the adjacent lane.

In addition, the controller 130 may be connected with a warning apparatus 160 configured to provide a notification (alarm) to the driver of the ego vehicle. If the controller 130 determines that the lane adjacent to the driving lane of the ego vehicle is congested, the controller 130 may control the warning apparatus 160 to notify the driver of the ego vehicle of the traffic congestion in the adjacent lane.

For example, the warning apparatus 160 may include at least one of a visual alarm device and an audible alarm device.

Meanwhile, the method for determining traffic congestion according to the embodiment of the present disclosure by the controller 130 has been described in detail above, so a detailed description thereof will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the above-described embodiment of the present disclosure, it is possible to provide a method and system for determining traffic congestion, which enables to respond quickly when entering the traffic congestion section, by determining whether the adjacent lane is congested using road information and information on surrounding vehicles in the autonomous driving system.

Furthermore, according to the embodiments of the present disclosure, since it is possible to determine whether there is traffic congestion in the adjacent lane using only the sensor(s) mounted at the ego vehicle, it is possible to determine whether there is traffic congestion even on a road where the infrastructure is not built.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

1: Ego vehicle
2: Front vehicle
3: Rear vehicle
4: Frontmost surrounding vehicle
5: Rearmost surrounding vehicle
100: System for determining traffic congestion
110: First sensor
120: Second sensor
130: Controller
131: Processor
140: Braking apparatus
150: Steering apparatus
160: Warning apparatus

1. A method for determining traffic congestion, comprising:
collecting road information on which the vehicle is driving and information on at least one surrounding vehicle driving in an adjacent lane using at least one sensor;
aligning the at least one surrounding vehicle based on a longitudinal distance from an ego vehicle and allocating at least one slot to the at least one surrounding vehicle, and determining retention or transition of the slot;
determining vehicle driving speed of the adjacent lane by using vehicle speed of the at least one surrounding vehicle;
calculating congestion degree of the adjacent lane in a congestion section based on a one-dimensional traffic flow model;
determining whether there is traffic congestion in the adjacent lane by using the congestion degree of the adjacent lane; and
controlling the ego vehicle according to whether there is the traffic congestion.

2. The method of claim 1, wherein in determining retention or transition of the slot, it is determined that the slot is retained if the number of at least one surrounding vehicle satisfying the retention time set for each slot is greater than a predetermined threshold value.

3. The method of claim 2, wherein the set retention time becomes longer as a distance of the slot from the ego vehicle increases.

4. The method of claim 1, wherein in determining retention or transition of the slot, it is determined that the slot is transitioned if the number of at least one surrounding vehicle satisfying the number of transitions set for each slot is greater than a predetermined threshold value.

5. The method of claim 4, wherein the number of transitions set for each slot increases as a distance of the slot from the ego vehicle increases.

6. The method of claim 1, further comprising:
setting s destination of the ego vehicle; and
generating a route to reach the destination of the ego vehicle.

7. The method of claim 6, wherein the controlling of the ego vehicle comprises controlling the ego vehicle according to the route and whether there is the traffic congestion.

8. The method of claim 1, wherein the determining of the vehicle driving speed of the adjacent lane is performed by using an average driving speed of vehicles driving in the adjacent lane.

9. The method of claim 8, wherein the controlling of the ego vehicle comprises performing deceleration control of the ego vehicle to reduce a speed of the ego vehicle to be the same as the vehicle driving speed of the adjacent lane if the adjacent lane is determined to be congested when the ego vehicle enters the adjacent lane.

10. The method of claim 1, wherein the calculating of the congestion degree comprises determining the congestion section variably depending on a type and a maximum detection distance of the at least one sensor of the ego vehicle.

11. A system for determining traffic congestion, comprising:
a first sensor configured to detect information of at least one surrounding vehicle driving in an adjacent lane;
a second sensor configured to detect road information on which an ego vehicle is driving; and
a controller comprising at least one processor configured to determine whether there is traffic congestion in the adjacent lane,
wherein the controller is configured to allocate at least one slot by aligning the at least one surrounding vehicle based on a longitudinal distance from the ego vehicle, determine retention or transition of the slot, determine vehicle driving speed of the adjacent lane using vehicle speed of the at least one surrounding vehicle, calculate congestion degree of the adjacent lane in a congestion section based on a one-dimensional traffic flow model, determine whether there is traffic congestion in the adjacent lane by using the congestion degree of the adjacent lane, and control the ego vehicle based on the result of determining whether there is traffic congestion.

12. The system of claim 11, further comprising:
a braking apparatus configured to control a longitudinal driving of the ego vehicle; and
a steering apparatus configured to control a lateral driving of the ego vehicle,
wherein the controller is configured to control at least one of the braking apparatus and the steering apparatus based on the result of determining whether there is traffic congestion.

13. The system of claim 11, wherein the first sensor comprises at least one of a front camera, a front radar, and a corner radar, and the second sensor comprises at least one of a GNSS (Global Navigation Satellite System), an IMU (Inertial Measurement Unit), and a navigation map.

14. The system of claim 11, wherein the controller is configured to determine that the slot is retained if the number of at least one surrounding vehicle satisfying the retention time set for each slot is greater than a predetermined threshold value, and the set retention time becomes longer as a distance of the slot from the ego vehicle increases.

15. The system of claim 11, wherein the controller is configured to determine that the slot is transitioned if the number of at least one surrounding vehicle satisfying the number of transitions set for each slot is greater than a predetermined threshold value, and the set number of transitions increases as a distance of the slot from the ego vehicle increases.

16. The system of claim 11, wherein the controller is configured to generate a route to reach a destination set for the ego vehicle, and control the ego vehicle based on the route and whether there is traffic congestion.

17. The system of claim 11, wherein the controller is configured to determine the vehicle driving speed of the adjacent lane by using an average driving speed of vehicles driving in the adjacent lane.

18. The system of claim 17, wherein the controller is configured to perform deceleration control of the ego vehicle to reduce a speed of the ego vehicle to be the same as the vehicle driving speed of the adjacent lane if the adjacent lane is determined to be congested when the ego vehicle enters the adjacent lane.

19. The system of claim 11, wherein the controller is configured to variably determine the congestion section depending on a type and a maximum detection distance of at least one sensor included in the first sensor.

20. A non-transitory computer-readable recording medium that records a program for executing a method for determining traffic congestion on a computer, the method comprising:
collecting road information on which the vehicle is driving and information on at least one surrounding vehicle driving in an adjacent lane using at least one sensor;
aligning the at least one surrounding vehicle based on a longitudinal distance from an ego vehicle and allocating at least one slot to the at least one surrounding vehicle, and determining retention or transition of the slot;
determining vehicle driving speed of the adjacent lane by using vehicle speed of the at least one surrounding vehicle;
calculating congestion degree of the adjacent lane in a congestion section based on a one-dimensional traffic flow model;
determining whether there is traffic congestion in the adjacent lane by using the congestion degree of the adjacent lane; and
controlling the ego vehicle according to whether there is the traffic congestion.
